(19) United States
(12) Patent Application Publication
(10) Pub. No.: US 2004/0062404 A1
(43) Pub. Date: Apr. 1, 2004

(54) Speaker system

(75) Inventors: Hirokazu Negishi, Kanagawa (JP); Yoshisuke Teshima, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/662,360

(22) Filed: Sep. 16, 2003

(30) Foreign Application Priority Data
Sep. 18, 2002 (JP) 2002-271679

(51) Int. Cl. H04B 3/00; H04R 1/02

(52) U.S. Cl. 381/77; 381/89

(57) ABSTRACT

Defects in principle of low-frequency sound reproduction that conventional technologies essentially have are overcome by using a novel method for performing direct modulation when an air-current occurs. There is provided a speaker system, including an air-current generating unit for generating an air-current, and an air-current modulating unit for frequency-modulating the air-current generated by the air-current generating unit with a sound signal to which the driving of the air-current generating unit is input to generate sound waves in accordance with the sound signal.

### BACKGROUND OF THE INVENTION

1. Field of the Invention

The present invention relates to a speaker system for converting an audio signal to an audio sound output by modulating a generated current of air in accordance with the input the audio signal and a active sound control system for operably controlling an echo sound of the low-frequency in a listening room, a reduction of a standing wave(a flutter echo) in the listening room and a leakage of the low frequency sound to outside of the listening room.

2. Description of the Related Art

Currently, in a generally used speaker system, a diaphragm predicated on reciprocating vibration is driven by a mechanism called a voice coil. The driving principle is the same as that of an electromagnetic motor and depends on Lorentz force.

The reciprocated diaphragm always generates inverse phase waves different in phase from the original reproducing waves by 180 degree. The inverse phase waves cause inference occurs between the original waves and waves in the surrounding space, therefore a high quality reproduction cannot be achieved. Especially, the lower the frequency has the longer the wavelength, the directivity is lost, and they therefore essentially cancel each other. As a result, the low-frequency sound output level attenuates in proportions of −6 dB/Oct.

Conventionally, an enclosure is used to enclose inverse phase waves for preventing the inference. Generally, an airtight enclosure may be frequently used. The length of the audio circuit is adjusted by using various kinds of ports, and the wavelengths about the minimum resonance frequency are resonated actively and are strengthened.

A method for strengthening only the specific band through a resonance effect by using multiple resonance boxes is also known. However, in these cases, because of the use of an enclosure, the load called backpressure substantially lifts the minimum resonance frequency F0 of the speaker and further increases the power required for driving.

A airtight box is certainly excellent in time characteristic but the sound pressure of low-frequency sound cannot be easily obtained. In addition, the enclosure itself cannot be completely acoustically dead. Thus, so-called unnecessary vibration is generated, which may cause distortion.

On the other hand, when a resonance effect is used, the low-frequency sound pressure in a normal measurement certainly increases. However, the time characteristic obviously decreases. In other words, a responsive characteristic concerning to the rise time and fall time deteriorate, because of the resonance phenomena, and the reproduction with high fidelity cannot be expected. As a result, the time characteristic may be given higher priority while the occurrence of sound pressure is sacrificed. Alternatively, the sound pressure is given higher pressure while the time characteristic is sacrificed. This trade-off is always involved in the low-frequency sound design for enclosures.

In response to the recent movement of energy saving/space saving, the reduction in thickness of speaker enclosures has been required more. However, the backpressure is inversely proportional to the volumetric capacity of an enclosure, which is more linked to the increase in load of the speaker.

As a result, F0 increases more with the same input, and the shortage of low frequency sound becomes clearer in sense of hearing, which can be only solved by the supply of a large amount of power. Apparently, this is against the concept of energy saving and is an outgrowth of compromise. In short, the conventional technologies reach the limit and cannot meet demands of the time. Extremely speaking, the existence of enclosures may reach the limit for low-frequency sound reproduction.

A general voice-coil type speaker and the limit of low-frequency sound reproduction caused by the principle have been described above.

On the other hand, the existence of an air-current flow speaker has been known as a special form. As is evident from the siren actuating principle, sound occurs when the current of air is modulated. This kind of conventional technology is disclosed in U.S. Pat. No. 1,904,156. Additionally, U.S. Pat. No. 2,442,565 aims for the practicality in the band of 300-3000 Hz. Furthermore, U.S. Pat. No. 5,054,080 aims for the improvement of the U.S. Pat. No. 2,442,565 with respect to the materials. All of them basically belong to the technology for modulating high-pressure fluid with audio signals.

Japanese Patent Publication No. 7-32518 discloses a method for modulating sound in a voice coil by using the pressure-reducing state occurring in a vacuum pump. Japanese Patent No. 02634402 focuses on the modulation method itself, and many openings are electromagnetically controlled by using audio signals. As a result, by vibrating an air valve in sideways, positive and negative pressures are caused on the front surface of the air valve.

An air-current speaker is clearly different from that of the voice-coil type speaker vibrating the diaphragm The difference is that the air-current type does not require any enclosure. This is because inverse phase waves do not occur in principle. It can be extremely effective for low-frequency sound reproduction that the principle disadvantage caused by the enclosure can be eliminated. Apparently, this characteristic is mainly for the method for modulating certain current and is not therefore essential.

By the way, an air-current speaker for the reproduction with fidelity has not been known up to this point. Though several conventional air-current speakers as described above have been known, the practicality is extremely limited. Few air-current speakers may have been at least commercially successful except for those for the application requiring high sound pressure, such as a deck of an air carrier. The principle is based on the premise of a constant air current (fluid current) as described above, and, mainly, the constant current is modulated by using audio signals. The method for modulating a constant current later is provisionally categorized as an indirect-modulation type air-current speaker method.

This method handles fast fluid and easily causes wide-band background noise fatally.

### SUMMARY OF THE INVENTION

It is an object of the present invention to overcome the defects in principle of low-frequency sound reproduction that the conventional technologies essentially have, by adopting a direct-modulation type air-current speaker, that is, a method for performing direct modulation when an air-current occurs.

It is another object of the invention to provide a speaker system without voice coils, which allows the high quality reproduction without distortion due to the minimum resonance frequency unavoidable in a voice-coil type speaker.

In order to achieve these objects, according to a preferred embodiment of the invention, there is provided a speaker system, including an air-current generating unit for generating an air-current, and an air-current modulating unit for frequency-modulating the air-current generated by the air-current generating unit with an audio signal to which the driving of the air-current generating unit is input to generate sound waves in accordance with the audio signal.

Further objects, features and advantages of the present invention will become apparent from the following description of the preferred embodiments with reference to the attached drawings.

### BRIEF DESCRIPTION OF THE DRAWINGS

FIG. 1 is a conceptual diagram of a direct-modulation air-current type speaker according to a first embodiment of the invention.

FIG. 2 is a conceptual driving speed comparison diagram where the vertical axis indicates rotational speed while the horizontal axis indicates time.

FIG. 3 is a conceptual exploded diagram of a rotational end front of an acoustic pulsometer.

FIG. 4 is a conceptual diagram for describing an active indoor low-frequency sound reverberation control method according to a second embodiment of the invention;

FIG. 5 is a diagram for describing a construction of an active indoor low-frequency sound reverberation control method according to the second embodiment of the invention.

FIG. 6 is a diagram for describing an arrangement of low-frequency sound speakers.

### DESCRIPTION OF THE PREFERRED EMBODIMENTS

First Embodiment

An embodiment of the invention will be described below. First of all, the technical concept will be clarified.

The technical concept of the invention is a high efficiency and a high quality of a low-frequency sound characteristic of for a speaker system for a low-frequency characteristic of reproducing unit achieving high quality, high efficiency, energy saving and space saving for a speaker. Three points of the limit of the conventional technologies were clarified by reviewing the principles of the current sound reproduction.

(1) First, we have an ultrasonic motor, different from a voice coil. The ultrasonic motor is a transducer for performing operations extremely with low power consumption and having a high-fidelity response to a driving signals. However, the ultrasonic motor as a driving source causes an instant time blank (like a backlash) at the inversion of reciprocal movement. The speed modulation in the rotation in one direction does not have the blank, which is a problem in principle.

(2) Second, the size and backpressure of a speaker are limited due to the enclosure, and the unnecessary vibration of the enclosure, which causes distortion, was focused. We aimed for enclosure-less. The point of view caused the introduction from an inhalation/exhaust system called fan to a direct undulation generating system called acoustic pulsometer.

(3) Third, we intended to use a driving source for modulating audio signals when the current itself was generated while a conventional speaker attempts to sound-modulate steady current. The concentration on the low-frequency reproduction by an ultrasonic motor realized the leap from the indirect modulation type to the direct modulation type. As a result, the high quality, high efficiency, energy saving and space saving characteristics of a sound, especially, low-frequency reproducing unit can be achieved.

According to the invention, an air-current type speaker includes a driving force 1, a driving input generating device 2 and a pulsometer 3. The air-current type speaker further includes a protection mask 4 for the pulsometer. The protection mask not only reduces the risk to users due to the movement of the pulsometer but also prevents the unnecessary occurrence of aerodynamic noise by protecting the pulsometer itself and by providing the operational space.

First of all, the driving source 1 may be an ultrasonic motor, especially, a progressive wave type ultrasonic motor. The driving input generating device 2 is similar to a driving circuit disclosed in Japanese Patent Laid-Open No. 8-79896 but is different in driving signals. In other words, in the conventional example, driving signals are used for causing reciprocating movement. On the other hand, according to the present invention, the driving input generating device 2 rotates in one direction, and the rotational speed is modulated by audio input signals. As a result, the driving source is driven so as to rotate in a fixed direction, and the rotational speed is changed in accordance with the audio input signal.

The pulsometer 3 receives the rotational force from the ultrasonic motor and rotates in a fixed direction. Then, the rotational speed is changed in accordance with the audio input signal. Generally, blades of a dual-tub washing machine are known as a pulsometer, but a slightly different aspect is adopted in the present invention. The different aspect is that the purpose of the blades is to generate sound waves in normal phase as effective as possible. A general washing machine has a form independent from the rotational direction since the purpose is to generate water flows. However, for acoustic purposes, the blades are asymmetrical with respect to the rotational direction in order to have a possibly large difference in sound wave generation between the normal phase and the inverse phase.

According to the invention, the pulsometer generates sound waves efficiently in accordance with the change in rotational speed. The function for generating sound waves works similarly in general electric and ventilating fans. These air-current generating mechanisms are basically reversible and symmetrical, and the rotational force is generated when the air-current hits the fan. However, in the pulsometer case, no rotational forces occur even when air-current hits the air-current generating surface. In other words, an acoustic pulsometer can be a non-reversible/asymmetrical sound wave generating mechanism.

This difference causes a difference in principle as a sound source. In other words, a reversible/symmetrical sound wave generating mechanism generates sound waves with inignorable inverse phase in inhaling process. This corresponds to the inverse phase component of a general reciprocating vibration type(a voice-coil type) speaker. In order to avoid this effect, an enclosure must be adopted. However, fewer inverse phase wavefronts occur in the non-reversible/asymmetrical sound wave generating mechanism like an acoustic pulsometer. Apparently, air current is inhaled near the pulsometer and is exhausted to the axial surface of the pulsometer. However, in comparison with the normal phase front for intentionally generating sound waves, sound waves are distributed all of the circumference of the inhaling side and a component of the sound wave in inverse phase are generated very little.

This is like the problem of an amount of air movement and a size of a diaphragm in a woofer speaker. In other words, the larger the size is, the higher the sound pressure is with the same amount of air movement. This is the same relation as that of the behavior of a diaphragm disk in an infinite baffle board. The radiation efficiency is inversely proportional to the radius of a diaphragm having a sufficiently small radius with respect to the wavelength. In the non-reversible/assymetrical sound wave generating device, the inflow and outflow amounts of air-current are the same but the sound pressures in the inverse phase and normal phase of sound waves are not the same. In other words, the inverse phase sound wave component in the inflow side is clearly less than the normal phase sound wave component of the outflow side. This also depends on the design of the pulsometer. It is important that waves in normal phase are created efficiently while eaves with inverse phases are suppressed as many as possible. That is, the asymmetrical characteristic must be increased.

Desired characteristics of a pulsometer includes not only the asymmetrical characteristic but also the higher conversion efficiency and higher rigidity/lower moment. First of all, the higher conversion efficiency means that the audio output is higher with respect to the driving force and depends on the form of the pulsometer blade. Next, the higher rigidity prevents the occurrence of unnecessary distorted sound due to the distortion of the pulsometer. The lower moment increases the efficiency with the same driving force by reducing the load as much as possible. More specifically, for example, a polystyroform laminate may be used as a core in order to achieve higher rigidity and lower moment. However, since a polystyroform laminate has higher glass transition point, unexpected uncomfortable sound may occur. Therefore, the sound generation from the pulsometer itself can be reduced by covering the polystyroform with a flexible material having a lower glass transition point, such as polyurethane. Furthermore, an acoustic pulsometer having higher rigidity and lower moment can be created. In this case, the lower moment is much lighter than that of a once-through fan such as a general electric fan. However, when the driving source has extra power, substantially the same performance can be achieved by providing an acoustic material for absorbing a sound on the back, for example, of the general once-through fan.

Finally, the protection cover 4 has at least three roles.

First, the protection is for preventing users from directly touching the rotating pulsometer.

Second, the protection cover 4 protects the pulsometer itself from external force. This is because the pulsometer itself is a sound generating body and has a delicate structure with higher rigidity and lower moment.

Third, the unnecessary occurrence of aerodynamic sound can be avoided. This is because the mechanism of the fluid sound generation has not been theoretically and entirely clarified and unexpected aerodynamic sounds can be prevented from occurring due to the approach with the other objects and/or constructions. Apparently, the visual beauty and the acoustic characteristic must be additionally considered.

A general electromagnetic motor may be apparently used as the driving source \mathring{1}. However, the responsivity and the necessity of feedback control are not always the same as those of the ultrasonic motor. A general electromagnetic motor and an ultrasonic motor may be used enough for the applications according to the present invention when they are optimally designed in accordance with the required capacity.

The specific construction will be described below.

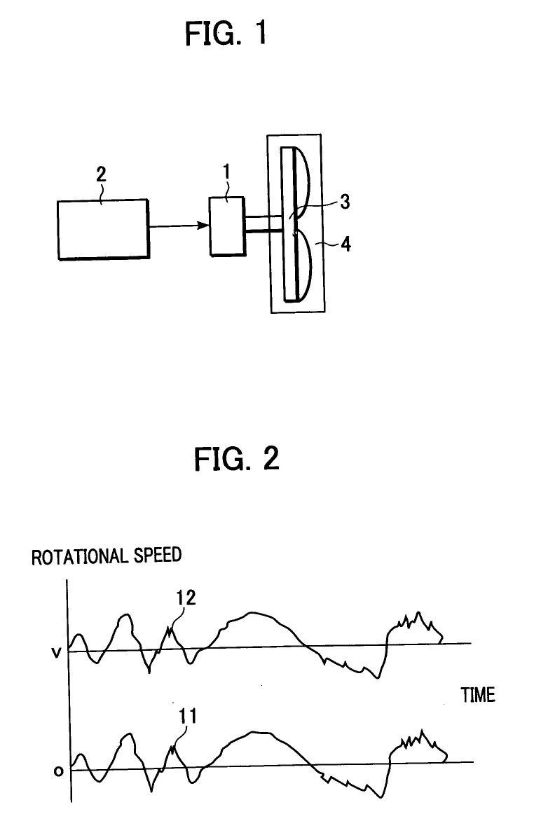

FIG. 1 is a principle diagram according to an embodiment of the present invention. First of all, the driving source 1 is an ultrasonic motor and receives a rotational input modulated with audio signals from the driving input device 2. The driving source 1 rotates at a fixed speed during standby and rotates by changing the rotational speed in accordance with the audio signal. The acoustic pulsometer 3 receives rotational force from the driving source 1 and rotates by changing the rotational speed in accordance with the audio signal. As a result, an audio output in accordance with the audio input can be obtained. The protection cover 4 protects the acoustic pulsometer 3.

FIG. 2 shows a typical driving input according to the present invention. The vertical and horizontal axes indicate driving speed and time, respectively. The reference numeral 11 indicates the driving input of a general speaker, that is, a reciprocating (voice-coil type) speaker.

In this case, The input from the driving source 1 is deviated up and down (corresponding to a normal direction and an inverse direction respectively) relative to a reference point where the speed is zero at a point of reflection according to the audio signal.

And the driving source is oscillated to left and right directions respect to the origin point, therefore the speed is zero at appoint of reflection. An instant blank at that time is a problem. On the other hand, the reference numeral 12 indicates a driving input of an air-current type speaker according to the present invention. In this case, the input becomes faster or slower in accordance with the audio signal with reference to a fixed speed. However, the width of deviation is determined narrower than the basic speed and is never inverted. Therefore, an instantaneous interruption does not occur.

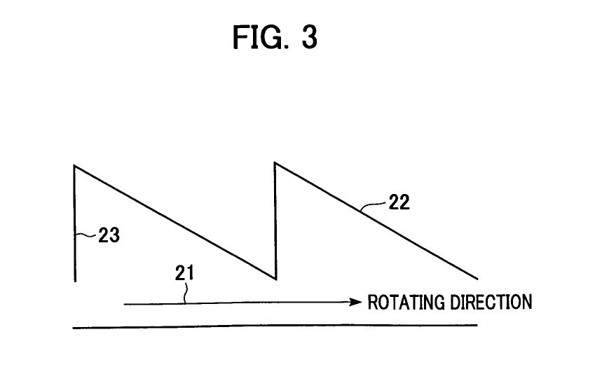

FIG. 3 conceptually shows an exploded diagram of the rotational end face, that is, the most peripheral part of the acoustic pulsometer. The reference numeral 21 indicates the exploded part of the rotational end face of the acoustic pulsometer. The reference numeral 22 indicates the normal phase slanting surface actively contributing to the sound generation.

On the other hand, an inverse phase front surface 23 is a non-sound-generating surface and is perpendicular to a general rotational surface. The slope of the normal phase slanting surface 22 increases from the end face to the center. When the acoustic pulsometer 21 rotates in the right direction as indicated by the arrow in FIG. 3, the normal phase slanting surface 22 is a sound generating surface. In other words, the air near there is pressed upward in FIG. 3, and the air particles are accelerated. In this case, when the audio input is zero and even when air current being pressed upward exists, the air particles keep the constant speed and are not further accelerated or decelerated. Thus, the air particles do not become sound waves. This is because sound waves finely change in speed of air particles, and particles in stationary current do not change in speed. However, once modulated with audio signals, the sound generating slanting surface of the pulsometer causes the upward change in particle speed in accordance with the change in speed. In other words, sound waves start oscillating. Basically, the particle speed is higher than the reference speed while the speed is increasing, and the particle speed is lower than the reference speed while the speed is decreasing.

In FIG. 3, the inverse phase surface 23 is a non-sound-generating surface as described above. This is because the inverse phase surface 23 does not have a function for accelerating or decelerating closer air particles upward irrespective of the increase or decrease in speed of the acoustic pulsometer. Therefore, the function for accelerating air particles by using the normal phase slanting surface 22 becomes the maximum value of the gross amount of sound generation. This is because the air to be pressed out by the normal phase slanting surface 22, which is the sound generating surface, must be supplemented anyway. Therefore, air is captured mainly from the vicinity of the periphery of the end face of the acoustic pulsometer. In this case, the particles with the inverse phase are naturally accelerated. However, the undulatory influence is intermittent and is not steady. In other words, the same amount of air moves, but the normal phase and the inverse phase are equivalent to a large diameter diaphragm and an extremely small diameter diaphragm, respectively. Apparently, the radiation impedance is inversely proportional to the diameter. As a result, in comparison with the normal phase generated by the normal phase slanting surface 22, that is the sound generating surface, the inverse phase may be ignored.

As described above, since the inverse phase surface 23 is perpendicular to the general rotating plane, the function for decreasing the speed of upward air particles does not exist. However, the accelerating and decelerating function obviously exists in the rotating direction. Since the wavelength of frequencies is long, the upward inverse phase component occurs as a result of the diffraction effect. In order to reduce the effect, the inverse phase surface 23 desirably has a sound-absorbing effect.

For example, a multi-fiber member such as fiber glass and a coupled porous member such as polyurethane form or the like may be effectively used for constructing the inverse phase surface 23 and the inside. Furthermore, a filter may be effectively provided so as to prevent clogging due to the inhalation of dust in air.

A first example of the driving source is a progressive waveform ultrasonic motor with the rated load torque of 0.098 Nm/73 rpm. The driving input amplitude/driving frequency-modulated in accordance with the audio signal at the driving frequency of 35 to 40 kHz is input from the driving input device. The pulsometer has the diameter of 30 cm and the maximum thickness of 8 cm. Six blades are provided, and the base part on the rotational end face is 3 cm. The pulsometer contains polystyroform, and the surface is coated with a urethane material so as to prevent the occurrence of unnecessary audible sounds.

The driving source has a margin two or more times of the rated torque, and the maximum number of revolutions is about 200 rpm. Thus, the basic rotational speed is changed to the maximum of 100 rpm in accordance with the volume of the audio system, and the depth of the sound modulation also adopts 70% of the maximum basic rotational speed. Therefore, for example, at 100 rpm, the modulation is performed in the range from the maximum of 170 rpm to the minimum of 30 rpm. The sound reproduction initially intended with this construction was recognized.

A second example of the driving source is a progressive wave motor with the rated torque of 0.432 Nm/73 rpm. Like the first example, the driving input amplitude/driving-frequency modulated in accordance with the audio signal is input from the driving input device. The pulsometer has the diameter of 60 cm and the maximum thickness of 13 cm. Six blades are also provided, and the base part on the rotational end face is 3 cm. The pulsometer also contains polystyroform, and the surface is finished with urethane.

Like the first example, the driving source has a margin two or more times of the rated torque, and the maximum number of revolutions is about 170 rpm. Thus, the basic rotational speed is changed to the maximum of 90 rpm in accordance with the volume of the audio system, and the depth of the sound modulation also adopts 70% of the maximum basic rotational speed. Therefore, for example, with the maximum output, the modulation is performed in the range from the maximum of 27 rpm to the minimum of 153 rpm. The sound reproduction with this construction exhibits sound pressure about four times of that of the first example.

The effects of the low audio frequency have been mainly described above. However, the present invention provides a highly efficient speaker totally for the low and mid frequencies. Since the mid and low frequency sound conventionally have the highest energy density in music reproduction, mid and low frequency sounds can be reproduced with low power consumption according to the present invention by selecting a higher driving frequency for the driving source and a smaller diameter for the pulsometer. In a progressive wave ultrasonic motor, as the diameter of the motor decreases, the power consumption decreases while the driving frequency increases. Thus, faster revolutions can be obtained.

<Second Embodiment>

A second embodiment of the invention will be described next. While the first embodiment relates to a speaker system, the second embodiment relates to a listening room having a speaker system to be driven. More specifically, the second embodiment relates to methods for reverberation control of low frequency sound, reduction of standing waves, and prevention of low-frequency sound leaks to the outside and the system.

Concretely, the second embodiment relates to an active indoor low-frequency sound reverberation control system wherein an algorithm of a signal generating circuit has a self-learning function, indoor reverberation information is collected and results of reverberation control are monitored as required during the system boot-up process so as to keep the audio condition equal to or higher than a certain quality level.

Low frequency sound is significantly important for sound production. This embodiment relates to indoor reverberation control of low frequency sound, reduction of standing waves, and prevention of pollution due to low-frequency sound leak to the outside for the sound environment.

In particular, this embodiment relates to a technology, for appreciation in a living/listening room at a general housing, for reducing unavoidable low-frequency sound reverberation, removing unnaturalness due to standing waves and adjusting them to optimum values and for preventing low-frequency sound pollution due to leaks to the outside, which are uncomfortable to third parties.

More specifically, a sound generating device, which is an indoor low-frequency sound generating source, and a low-frequency sound generating sound source for ANC(active noise control) type control aiming for reverberation control and/or standing wave control as required are used. These sound sources are provided at proper positions and apply an autoadaptuve ANC technology, which allows the control of reverberation conditions, reduction of standing waves and reduction of low-frequency sound leaks to the outside. Especially, an ultrasonic motor speaker is used as the sound source for a low-frequency sound source for reproduction and a low-frequency sound source for control such that the active indoor low-frequency sound reverberation control method can be obtained, which cannot be achieved by conventional adaptive ANCs.

First of all, the background technologies will be described. Generally, an indoor space in a house, for example, has more reverberation as a sound reproducing environment when the space is not furnished. The arrangement of furniture generally supports the reverberation time control. However, the indoor reverberation control intended for a sound environment further can reduce the reverberation time. Generally, in order to reduce reverberation, a passive control method is adopted. In other words, a sound absorbing material is provided on the wall such that the sound reflectivity on the wall can be reduced, resulting in an intended reverberation time.

The passive reverberation control method using the sound absorbing materials is effective for mid and higher audio frequency and is fully used irrespective of the size of the indoor space. However, few sound absorbing material having a sound absorbing characteristic proper for the lower audio frequency are provided. Thus, various kinds of resonance phenomena, which are also passive sound absorbing processing, are combined. However, the passive low-frequency sound reverberation control is generally limited in ability, and the room overflows with the original sound and the reverberation as extra sound energy. Furthermore, many of sound absorbing materials are not visually proper for a living/listening room and have many constraints because of hostile housing circumstances. As a result, the implementation of the satisfactory low-frequency sound environment is difficult, and sound creation lacking reality is forced.

A problem inherent to low-frequency sound is standing waves occurring in the room. This is the same principle as “flatter echo”, and sounds reflected by facing walls interferes with each other. As a result, resonance sound not included in the original sound occurs. This is obviously different from general reverberation and time-spatially has an uneven distribution. In other words, an acoustic energy distribution occurs in the room, and the frequency unique to the place may be emphasized and be attenuated in accordance with the average value. The secondary effect is to spur the low-frequency sound leaking phenomenon to the outside. This is called low-frequency sound pollution and may be a large inhibition cause to the creation of a home sound environment. In the end, a paradigm that the sound creation in a general house must be compromised for many reasons is currently dominant.

The limitations of passive reverberation control and the paradigm based on the limitations have been described above. However, an active noise controller (ANC) may be used. ANC cancels energy of intended sound waves by superposing the intended sound waves on inverse phase waves. The ANC is more effective as the wavelength of the low frequency sound increases. The ANC and the passive reverberation control complement each other in a target frequency range. Apparently, the ANC is also effective against standing waves and low-frequency sound pollution. A so-called early decay time (EDT) is uniquely more dominant in auditory sense in a small space such as a living room. The active reverberation control is more effective for reducing the EDT and is more effective against the low-frequency sound leaking to the outside for the same reason than the passive reverberation control.

However, the applications of the ANC are limited. For example, like an air-conditioning duct to a concert hall, for example, the ANC may be handled as a one-dimensional sound field. An example of the application to a three-dimensional space is an active noise reducing method inside of a car, as disclosed in Japanese Patent Laid-Open No. 06-051787. However, the application is not the control of the reverberation time intended by the present invention but the reduction of noise. Simulation examples of various ANCs have been reported in academic meetings, but those examples are mainly about the way of suppressing acoustic energy from a target sound source at a control position.

As an application example to a few indoor reverberation control, Acoustic Lab of Switzerland has developed products for canceling resonance and/or antiresonance in the reduction by using an acceleration sensor. The acceleration sensor is used to monitor and detect indoor reactions at all times and to feedback the results to a regulator. Furthermore, the use of a significantly fast responsive subwoofer without delays occurring in reduction has been reported. In order to control sound fields, a speaker without delays is required.

However, in the system, the low-frequency sound technology is of bass-reflex type (low-frequency resonance reinforcement) using a voice coil as a driving source. The bass reflex type essentially obtains sound pressure reinforcement by sacrificing delays in time characteristic. In other words, the speaker of the system essentially has delays. Therefore, Claims by Acoustic Lab contain a contradiction.

As described above, conventional technologies mainly relate to the passive low-frequency sound reverberation control method but are not perfect. On the other hand, the active method may relate to noise reduction technologies for limited applications or may contain technical contradiction like the Acoustic Lab does.

This is because technologies for concretizations have not reached the satisfactory level for applying the method for indoor reverberation control for home uses, for example. Especially, outputs and time characteristics of speakers are not satisfactory in low audio frequencies. In other words, not only listeners in the room do not audibly satisfy with the conventional technologies but also the third parties outside do not satisfy with the pollution of low-frequency sound leaks. As a result, compromizations are forced, and the real sound creation is difficult. Since specific improving methods have not been found for a long period of time, the status quo has become a paradigm as a result.

The problems to be solved by the present invention by using the embodiment mentioned below includes the reverberation control for low audio frequencies, the reduction of standing waves and the reduction of low-frequency sound leaks to the outside of the space. Especially, the embodiment intends to meet optimal reverberation conditions for low audio frequencies, reduce standing waves and reduce the pollution of low-frequency sound leaks to the outside of the space in a listening/living room for home uses in accordance with the sound environment and/or the usage.

First of all, the technical ideas of the present invention will be clarified. It is a first object of the invention to achieve the active low-frequency sound reverberation control in a room, especially, in a listening/living room for home uses and the reduction of standing waves. It is a second object to reduce the pollution of low-frequency sound leaking to the outside of the space. Therefore, a low-frequency sound generating source is located at a proper position in the space. Then, the changes in wave motion are accurately realized in a time-space manner, and the wave motion with the phase inverse to that of the wave motion is generated in the same time-space. Thus, the reverberation of low-frequency sound in the space can be controlled. At the same time, it reduces the low-frequency sound leaks to the outside of the space, which contributes to the prevention of the pollution.

More specifically, a low-frequency sound generating source is located properly in the space. Then, the time-spatial acoustic characteristic is realized accurately. In this case, measuring the low-frequency sound leaking to the outside of the space is more effective.

Next, low-frequency sound is actually generated in the space, and sound waves having the phase inverse to that of the original sound are generated by a control sound source located at a proper position in accordance with the time-spatial spread of the wave motion. Both of them interfere with each other in the space, resulting in the control of reverberation of low-frequency sound and the reduction of standing waves. Furthermore, the pollution of low frequency sound leaking to the outside of the space can be reduced at the same time as a result.

This embodiment will be described more specifically below for a case where reproduced sound is used indoors. Sound source information of reproduced sound has been identified and may be applied as required. Apparently, the present invention is applicable to sound, which has not been generated before in the room, such as sound generated by performing instruments. In this case, the generated sound must be captured by the system first of all. The location of the sound generating source is not limited to the position optimal for reverberation control, which is common to both of them. This is because a sound generating source is highly possible to be located at a position optimal for sound creation, which is the original purpose. However, through the application of the invention, the reverberation control and the reduction of standing waves and low-frequency sound pollution may be factors of the optimums.

First of all, a basic characteristic of standing waves is determined in accordance with the specific acoustic conditions of the room. Furthermore, a specific standing wave is determined in accordance with the location of the sound source. Generally, the sound source is not located at a position strengthening standing waves in audibly important frequencies in accordance with audio common senses.

Once the reproduction starts, wave motions are propagated from the low-frequency sound generating source inside of the room. The form of propagating wave motions is known, and the location of the sound source for control is also known. Therefore, when waveforms having the phase inverse to that of sound waves propagating are accurately generated from the sound source for control, the acoustic energy reaches zero at the control sound source position.

The quality of reverberation in a concert hall is not determined only by the time. It is well known that the evaluation also depends on the attenuation curve and the direction that reflected sound comes from. However, the reverberation of reproduced music due to the listening environment is noise. However, though technically possible, nobody uses an anechoic chamber as a listening room in reality. This is because listeners may feel uncomfortable in a dead space without reflections, which is not suitable for music appreciation. In other words, when the reverberation practically innocuous to reproduced music can be obtained in a listening/living room, the way for reducing energy may be focused in order to suppress the low-frequency sound pollution. Under this condition, the reverberation in a given space may be simulated by using Kirchhoff equation.

First of all, the ideal control case will be described. Low-frequency sounds do not have directivity, and sound waves are propagated in equal strength in all directions. Normally, audiences only need to receive incoming sound (first wave) directly from the reproduced sound generating source. However, in reality, indirect sound (second wave and later) reflected by walls, for example, of the room also coexists in the same space. The time until these coexisting sound wave energy decreases by 60 dB from the first wave is called reverberation time. Though EDT may be focused, reverberation will be described below as an example. The general passive sound absorbing processing alone does not have enough ability or costs high. Then, in order to perform active reverberation control, the low-frequency sound with the inverse phase is generated from the control sound source. The same action is also effective for the reduction of standing waves and the reduction of the pollution of low-frequency sound leaks to outside of the space.

The position of a sound source in the room is uniquely set in accordance with the sense of hearing. Generally, the lower the frequency is, the harder the position of a sound source is specified. In other words, the lower the frequency of the reproduced sound is, the harder the position of the sound source is recognized. Therefore, the presence is checked first. Apparently, in reality, the low audio frequency is more strengthened at the corners due to the reflections from the walls, which must be noted. However, when the sound source is placed apart from the wall surface, the reflection waves from the wall surface at the back of the sound source interfere with the direct waves, which causes a valley in sound-pressure distribution in the front direction. Here, a case where the low audio frequencies are only generated independently from a woofer will be described. In this case, a reproducing sound source is located at the front corner of a hexagonal listening/living room, and a sound source for control is placed at the symmetrical position. Sound having the inverse phase is generated from the control sound source such that the propagation output of low-frequency sound from the reproducing sound source can be cancelled and the aiming reverberation time can be achieved.

In order to more specifically perform the reverberation control, the quality of the control output is important. Though the generation of an ideal inverse phase may be assumed in a simulation, the inverse phase from a real system is always different from the ideal inverse phase. Thus, how the control sound source can be driven more closely to the ideal is important. A conventional low-frequency sound speaker has critical defects as the one for an adaptive ANC, such as the frequency-dependency of phases, shortage in output and the slower response to rises. These defects depend on the nature of a transducer of the speaker and may unavoidably occur in so-called voice coil type electromagnetic conversion. In order to overcome the defects, the transducer must be strongly served, resulting in an increase in power consumption.

The present invention attempts to overcome the defects, which are not possible for conventional technologies, by using an ultrasonic motor as a transducer. In other words, since an ultrasonic motor speaker is excellent in reproduction of low-frequency sound with high fidelity and is superior to the conventional technologies also in the outputs, phases, responsivity and power consumption. Therefore, when the ideal control conditions obtained from the simulation are met, the control can be easily achieved, which has been difficult for conventional transducers. As described above, the reduction of EDT for low-frequency sounds is effective for the reduction of low-frequency sound pollution as described above. Therefore, the generation of inverse phase sound having the strength and waveform equivalent to incoming direct sound from, the control sound source is effective. In other words, source sound signals delayed by an amount corresponding to an acoustic path by the control circuit are generated from the control sound source at the inverse phase. In reality, the acoustic path between the sound source and the control sound source has a distribution, and control sound is also superposed thereon. Therefore, as more orders of reflection are superposed, the waveforms of the controlled sound are more different from the original sound. Naturally, the changes in waveform also reflected on the adaptive control signals.

It is an object of this embodiment is to control reverberation sound and is not to silence. Therefore, in reality, the waveform and strength of control sound are optimized by performing a simulation or an actual measurement in accordance with the target space, and the intended reverberation is obtained. In this case, the generation of control sound may be from not only the control sound source but also the original sound generating sound source. Since the superposition of waveforms is a linear phenomenon, the control sound may be superposed on the original sound for use.

The higher the number of control sound sources is, the easier the control is. However, by using only the original sound source, the control sound may be superposed on the original sound. Furthermore, instead of an independent woofer, only the low-frequency sound part of a speaker for all bands may be apparently the target of the sound source/control. Naturally, the number of the original sound source is not limited to one, but multiple original sound sources may be provided.

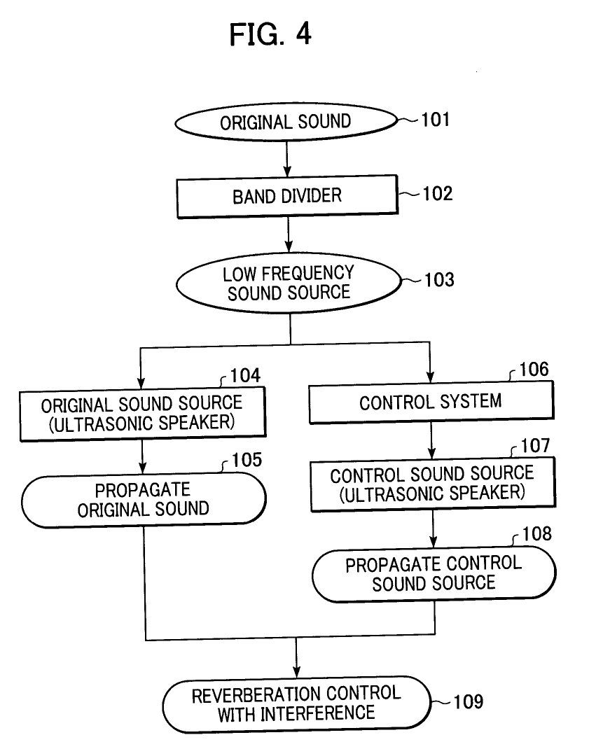

This embodiment will be more specifically described below. FIG. 4 shows a concept diagram of the present invention.

In FIG. 4, the reference numeral 101 indicates a sound source for reproduction for the entire bands. The reference numeral 102 indicates a band divider and includes a low-pass filter, a band pass filter and a high-pass filter.

The reference numeral 103 indicates a sound source for low audio frequencies to which the present invention can be applied. The reference numeral 104 indicates a low-frequency sound speaker, and the reference numeral 105 indicates original sound propagated from the speaker into the room.

On the other hand, the reference numeral 106 indicates a circuit for generating controlled sound. Control sound waves 108 are supplied to the low-frequency sound speaker 107 with ultrasonic motor for control and are propagated in the room. As a result, the interference 109 occurs, and the reverberation is controlled.

FIG. 4 shows an example where controlled sound is created from original sound. However, a microphone may be provided in the room as a sensor, and information may be obtained.

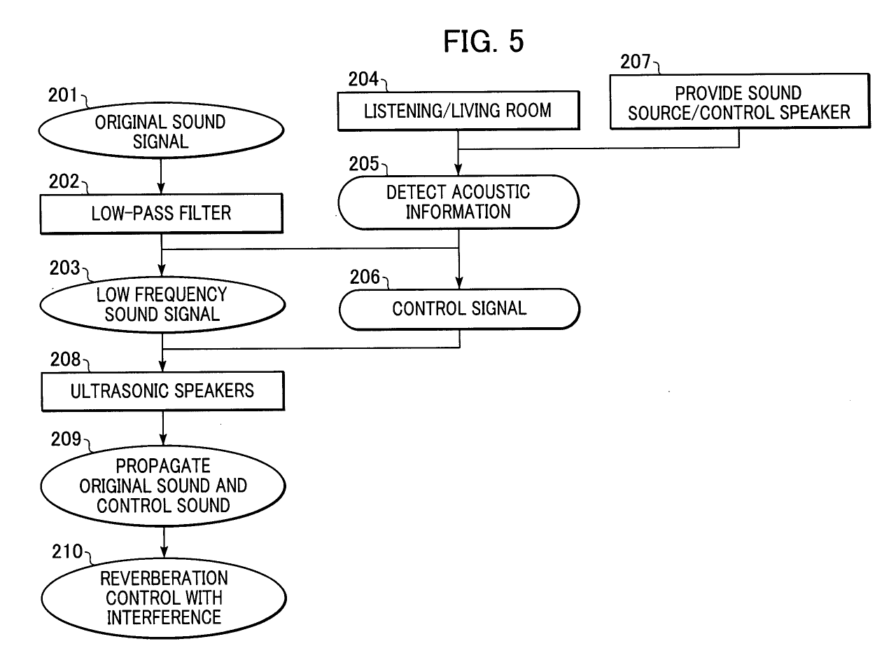

FIG. 5 shows one of examples. An original signal 201 obtains a low-frequency sound signal 203 to be controlled by the low-pass filter 202.

On the other hand, a listening/living room 204 has a unique acoustic characteristic. Furthermore, the location 207 of a reproducing sound source/control ultrasonic speakers is determined, and an acoustic characteristic 205 of the reproducing space is obtained by performing a simulation or an actual measurement.

Then, a low-frequency sound signal 203 is obtained from the low-pass filter 202 while a control signal 206 is obtained from the acoustic characteristic 205 of the reproducing space. The original sound, the control sound 209, the control signal 206 and the low-frequency sound signal 203 are propagated in the room from the ultrasonic speakers 208 for reproduction/control. As a result, the sound waves interfere with each other in the room, and the reverberation control 210 is achieved.

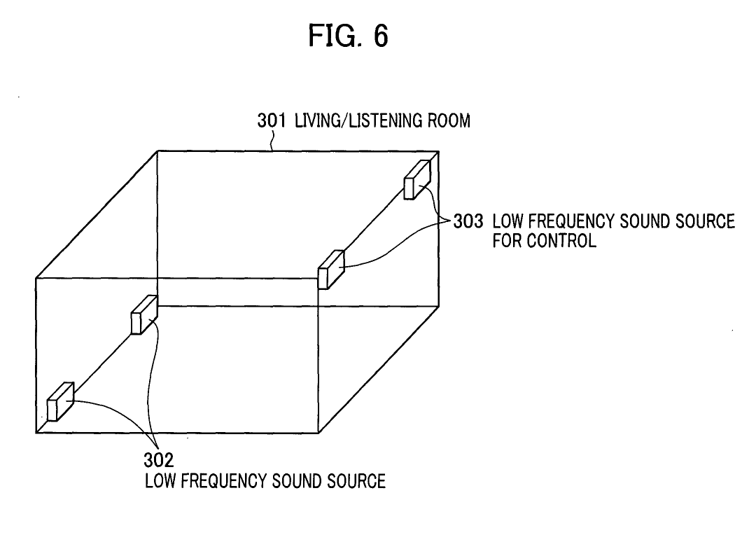

FIG. 6 is an example of the arrangement of low frequency sound speakers. In this example, the arrangement can achieve the good acoustic balance and the higher reverberation control efficiency. First of all, low-frequency sound sources 302, which are original sound sources, are provided at both front corners of a living/listening room 301, which is the applicable space.

On the other hand, low-frequency sound sources 303 for reverberation control are provided near both corners on the back ceiling. First of all, a test signal is output from the original low-frequency sound source, and the acoustic characteristic of the space is realized. Then, a control signal is simultaneously output from the low-frequency sound source for control, and changes in sense of hearing and/or in amount of reverberation are checked. Furthermore, data about the pollution of low frequency sound to the outside of the room is obtained, and the optimization is attempted in consideration of these characteristics.

These indoor acoustic conditions are constant within the specific limits for the low-frequency sound reproduction. Therefore, these indoor acoustic conditions do not have to be monitored at all times and may be used as compensation conditions as far as the indoor acoustic conditions are largely changed. Apparently, by using the learning function, the indoor acoustic conditions can be re-adapted as required, such as during the system boot-up. In the reproduction step, the low-frequency sound component is transmitted from the sound source ultrasonic speaker 302 into the room.

On the other hand, by folding in the compensation conditions and an original audio signal, control sound waves having the inverse phase are released from the control ultrasonic speaker 303 when the original speed is obtained. Thus, both of the waves interfere so as to weaken each other in the indoor space, and a silencing effect of the primary reflection occurs. As a result, the reverberation component decreases, and the EDT is reduced with the reduction of standing waves. The low-frequency sound leaks to the outside of the room are also reduced.

The reverberation control up to the primary reflection has been described above. However, higher order of reflection may be controlled. This is because the acoustic path from the original low-frequency sound source to the control low-frequency sound source has a distribution and is in a three-dimensional space but the control points are limited. Furthermore, when control waves having higher sound pressure are generated from the back for one-step silencing, the original sound may be lost. Fortunately, the transmission function after waves go and return on the acoustic path can be easily simulated or observed.

A program control method is provided in which the original low-frequency sound source may be regarded as a control low-frequency sound source and the original sound is gradually erased multiple times at both of the low-frequency sound sources. This method is suitable for systems requiring high fidelity. In this case, sound waves continuously generated in this way can be controlled independently because the linearity is obtained.

As described above, according to the active indoor low-frequency sound reverberation control method, the basic factors preventing low-frequency sound reproduction with high fidelity in a living/listening room, for example, can be removed. Especially, because of the reduction of the amount of primary reflection due to the interference effect, the reduction of standing waves, the reduction of early decay time (EDT) and the reduction of low-frequency sound leaks to the outside of the room can be improved to the level, which cannot be obtained by the conventional passive sound absorbing processing.

Thus, even ultra low-frequency sound audio frequencies can be reproduced, which has been conventionally difficult, in a living/listening room without uncomfortable acoustic phenomenon and the low-frequency sound pollution.

Furthermore, by program-controlling the higher order of reflection, a desired reverberation characteristic can be obtained in a system requiring high fidelity. This method allows the low-frequency sound reverberation control for an applicable room by using one low-frequency sound generating source. Conversely, the satisfactory low-frequency sound reverberation control can be performed in a small theater for thirty audiences, for example. Therefore, the system can be more flexible.

As described above, by using a direct-modulation type air-current speaker, no voice coils are required, and the high quality reproduction can be achieved without the distortion due to the minimum resonance frequency unavoidable to a reciprocating type(a vice-coil motor type) speaker.

An enclosure can be removed, and the necessity for the large amount of power consumption because of the backpressure due to the enclosure is eliminated. The totally high efficiency can be obtained, and an increase in power consumption can be prevented, which contributes to energy saving.

A driving source can be located near a pulsometer and without an enclosure, which can provide a thin and space-saving speaker. Furthermore, an innovative design providing functions obviously different from those of conventional systems can be expected.

Especially, these effects are remarkably exhibited in low-frequency sound reproduction, and problems due to the minimum resonance frequencies can be more overcome than the conventional reciprocating type speaker. The low-frequency sound design of the speaker system can be easily implemented, and the resonance and/or distortion due to the enclosure can be improved at the same time. These effects can be obtained not only in low-frequency sound reproduction but also in middle range audio frequencies.

According to the active sound control method of the present invention for controlling a low-frequency component in the listening room, even ultra low-frequency audio sound can be reproduced, which has been conventionally difficult, in a living/listening room without uncomfortable acoustic effect and the low-frequency sound noise.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A speaker system, comprising:
air-current generating means for generating an air-current; and
air-current modulating means for frequency-modulating the air-current generated by the air-current generating means with an audio signal to which the driving of the air-current generating means is input to generate sound waves in accordance with the audio signal.

2. A speaker system according to claim 1, wherein the air-current generating means includes a pulsometer rotating device for generating an air current, and the air-current modulating means modulates the air current by changing the rotational speed of the pulsometer in one direction in accordance with the audio signal.

3. A speaker system according to claim 2, wherein the pulsometer rotating device includes an ultrasonic motor as a driving source and an acoustic pulsometer with low moment and high rigidity.

4. A speaker system according to claim 2, wherein the form of blades/material of the pulsometer are asymmetrical with respect to the rotational direction, and the pulsometer reproduces sound waves in normal phase efficiently and can suppress the reproduction of sound waves in inverse phase.

5. A speaker system according to claim 2, wherein the pulsometer rotating device includes an electromagnetic motor as a driving source and an acoustic pulsometer with low moment and high rigidity.

6. A speaker system according to claim 1, wherein the air-current generating means has a sound absorbing material on the back of a fan for generating air currents.

7. An active indoor low-frequency sound control method in an audio reproducing system, in which a low-frequency sound source for reproduction and a low-frequency sound source for control are provided in a same room, and an adaptive control signal generating circuit is provided for controlling the low-frequency sound source for control,
wherein the control of indoor active low-frequency reverberation, the reduction of standing waves and the reduction of an amount of leaks of low frequency to the outside of the room can be achieved.

8. An active indoor low-frequency reverberation control method according to claim 7, wherein a microphone as a control signal source for the adaptive control signal generating circuit is located as required inside or outside of the room.

9. An active indoor low-frequency reverberation control method according to claim 7, wherein an ultrasonic motor speaker is used as the low-frequency sound source for reproduction and the low-frequency sound source for control.

10. An active indoor low-frequency reverberation control method according to claim 7, wherein the low-frequency sound source for reproduction also functions as a sound source for control.

11. An active indoor low-frequency reverberation control method, in which an acoustic generating source and an acoustic signal collecting device for collecting sound generated by the acoustic generating source, and a sound source for control are provided in a same room, and an adaptive control signal generating circuit is provided for controlling the low-frequency sound source for control,
wherein the control of indoor active low-frequency reverberation, the reduction of standing waves and the reduction of an amount of leaks of low frequency sounds to the outside of the room can be achieved.

12. An active indoor low-frequency reverberation control method according to claim 11, wherein ultrasonic motor speakers are used as the low-frequency sound source for reproduction and the low-frequency sound source for control, and the sound sources are arranged symmetrically in the room.

13. An active indoor low-frequency reverberation control system, comprising:
a sound source;
a filter for selecting a target range of frequencies from the sound source;
an adaptive control signal generating circuit; and
low-frequency speakers for sound source reproduction and for reverberation control arranged in a same room,
wherein the control of indoor low-frequency reverberation, the reduction of standing waves and the control of leaks of low-frequency sounds to the outside of the room can be achieved.

14. An active indoor low-frequency reverberation control system according to claim 13, wherein a microphone is used as the indoor acoustic information sensor such that acoustic signals can be supplied to the adaptive control signal generating circuit.

15. An active indoor low-frequency reverberation control system according to claim 14,
wherein an algorithm of the adaptive control signal generating circuit has a self-learning function, and acoustic conditions at a certain or higher quality level by collecting acoustic information of the inside of the room as required during the system boot-up and by monitoring results of reverberation control.
